(19) United States
(12) Patent Application Publication
(10) Pub. No.: US 2003/0204553 A1
(43) Pub. Date: Oct. 30, 2003

(54) Information handling system and program for use on a network, and a process of forming a relationship between global resources and local descriptions of those resources

(76) Inventor: Eamoon Neylon, Bicester (GB)

Correspondence Address: LOWE HAUPTMAN GILMAN & BERNER, LLP, Suite 310, 1700 Diagonal Road, Alexandria, VA, 22314, US

(21) Appl. No.: 10/128,575

(22) Filed: Apr. 24, 2002

(51) Int. Cl. G06F 15/163; G06F 9/54; G06F 9/00

(52) U.S. Cl. 709/104; 709/310

(57) ABSTRACT

An information handling system for use on a network storing multiple resource information includes a global resolution system programmed to return, in response to a lookup request specifying a unique identifier selected from many unique identifiers, a set of indexed resources corresponding to the identifier specified in the lookup request. At least one local resolution system is programmed to return, in response to a lookup request specifying a unique identifier selected from a multitude of unique identifiers, a set of indexed resources corresponding to the identifier specified in the lookup request. A registration management system organizes the global and local resolution system contents. Each local resolution system uses a local data structure which mirrors the global data structure. Each local data structure stores, as its resources, indexed, locally-contextual descriptions of the corresponding resources of the global resolution system.

### FIELD OF THE INVENTION

The present invention relates to accessing pieces of information about a particular subject, and is particularly relevant in a networked environment.

### BACKGROUND OF THE INVENTION

In the context of the present invention, pieces of information are referred to as resources, and there are resolution systems which associate unique identifiers with sets of such resources.

One form of resolution system known as the Handle System uses a name as an input to a system in order to return some resources. The Handle System is defined by the Corporation for National Research Initiatives (CNRI) and is described in the following publications:

Robert Kahn and Robert Wilensky, “A Framework for Distributed Digital Object Services”, May 13, 1995. [doi:cnri.dlib/tn95-01]

Laurence Lannom. “Handle System Overview”. ICSTI Forum, No. 30, April 1999.

Sam Sun and Larry Lannom, “Handle System Overview”. IETF Internet Draft, April 2001

Sam Sun, Sean Reilly, Larry Lannom and Jing Shi, “Handle System Protocol (ver 2.0) Specification”. IETF Internet Draft, April 2001

Sam Sun, Sean Reilly and Larry Lannom, “Handle System Namespace and Service Definition”. IETF Internet Draft, April 2001

Christophe Blanchi and Jason Petrone, “Distributed Interoperable Metadata Registry”, D-Lib Magazine, December 2001. [doi:10.1045/december2001-blanchi]

Larry Lannom, et al., “Linking to the Appropriate Copy”, D-Lib Magazine, September 2001. [doi:10.1045/september2001-caplan]

Robert E. Kahn and Vinton G. Cerf, “What is the Internet (And What Makes It Work)”, Internet Policy Institute, December 1999.

Brian L. Tierney, Jason Lee, Brian Crowley, Mason Holding, Jeremy Hylton and Fred L. Drake, Jr., “A Network-Aware Distributed Storage Cache for Data Intensive Environments”. Proceedings of the IEEE High Performance Distributed Computing Conference (HPDC-8), Redondo Beach, Calif., August 1999. Also available as Lawrence Berkeley National Laboratory Technical Report LBNL-42896.

Sandra Payette, Christophe Blanchi, Carl Lagoze and Edward A. Overly, “Interoperability for Digital Objects and Repositories: The Cornell/CNRI Experiments”, D-Lib Magazine, May 1999.

The Handle System is a comprehensive system for assigning, managing and resolving persistent identifiers, known as “handles” for digital objects and other resources on the Internet. Such “handles” can be used as Uniform Resource Names (URNs). It is understood that applications using the Handle System are being implemented by a growing number of organisations, and that it is written in Java (Trade Mark) and is available on the Internet. Currently, it can be accessed at http;//www.handle.net. Its protocols enable a distributed computer system to store handles of digital resources and to resolve those handles into the information necessary to locate and access the resources. This associated information can be changed as needed to reflect the current state of the identified resource without changing the handle, thus allowing the name of the item to persist over changes of location and other state information. Each handle may have its own administrator(s) and administration can be done in a distributed environment. The name-to-value bindings may also be secured, allowing handles to be used in trust management applications.

Such information resolution systems may be used in an information management system known as RDF (Resource Description Framework) which is specified by the organisation World Wide Web Consortium.

In systems where the response to a resolution request is intended for machine use, it is not necessary to label the resources. However, in situations where a human being may need to decide between alternative resources, those resources need to be described in order to assist human understanding. Existing resolution systems such as the Handle System are global in nature, so there is only one possible response from such systems, regardless of the context in which the request is made. The system is unable to recognise the varying requirements of different requesters, and unable to recognise local context.

Thus there is a need to provide a system in which the returned information is made more meaningful for a requester, by responding to information about the requester's locality or individual requirements. One example would be to provide information in a specific language; another would be to provide information in a specific layout or format; and another example would be to provide a level of complexity to suit the age of the requester, i.e. adult or child or infant.

### SUMMARY OF THE INVENTION

Accordingly, the present invention provides an information handling system for use on a network storing information in the form of multiple resources, comprising:

a global resolution system, which is programmed to return, in response to a lookup request specifying a unique identifier selected from a multitude of unique identifiers, a set of indexed resources corresponding to that one identifier specified in the lookup request;

at least one local resolution system, which is programmed to return, in response to a lookup request specifying a unique identifier selected from a multitude of unique identifiers, a set of indexed resources corresponding to that one identifier specified in the lookup request;

and a registration management system for organising the content of the global and local resolution systems;

wherein each local resolution system uses a local data structure for its resources which mirrors the global data structure for its resources, and wherein each local data structure stores, as its resources, locally-contextual descriptions of the corresponding resources of the global resolution system. The resources, both global and local, are preferably typed, i.e. given a label indicative of the type of information provided by the resource.

The system allows a user to make resolution requests, such requests specifying the required identifier.

It will be appreciated that in a networked system an identified entity may have multiple resources associated with it. This constitutes the set of resources. The resources within a resource set will have a relationship between themselves that may not be explicitly defined: such is the case with the Handle System referred to above. In order to provide a useful data structure, each resource preferably has associated with it an index and a type. The type refers to the nature of the information in the resource, and may for example be “url” or “public key” or “location”. One particularly important type of resource is a label, which is referred to as a description: the description provides a human readable explanation of a resource and needs to be associated with a particular resource through an appropriate mechanism. The present invention separates global resources from local resources and allows them to be combined using a dedicated service.

Thus the system of the invention preferably comprises a local proxy service system operable, in response to local resolution requests specifying a unique identifier, to merge the indexed global resources corresponding to that identifier with their corresponding locally-contextual descriptions, using the global and local resolution systems, and to provide a local context-specific presentation of the merged resources and descriptions.

The order in which the information is presented in response to a request is often of great importance, and accordingly it is a preferred feature of the invention that each said set of indexed resources and each set of indexed descriptions includes a map for the data structure of that identifier, indicative of a sequence in which the resources or descriptions are to be made available to a requester using the corresponding resolution system.

The invention also provides a corresponding process of forming a relationship between global resources and local descriptions of those resources by storing them in global and local data structures with mirrored formats, such that a global resolution system is capable of returning, in response to a lookup request specifying a unique identifier selected from a multitude of unique identifiers, a set of indexed resources corresponding to that one identifier specified in the lookup request, and at least one local resolution system is capable of returning, in response to a lookup request specifying a unique identifier selected from a multitude of unique identifiers, a set of indexed resources corresponding to that one identifier specified in the lookup request; in which the resources of the local resolution system comprise the corresponding local descriptions of the global resources.

Further, the invention provides a computer network programmed with an information handling system as defined above, and a storage medium containing a computer program for carrying out the process of the invention.

### BRIEF DESCRIPTION OF THE DRAWINGS

FIG. 1 is a schematic diagram of the relationship between multiple resources and an identifier;

FIG. 2 is a schematic diagram of the administration system for global and local resolution systems in a preferred embodiment of the invention;

FIG. 3 is a schematic diagram of the role of a proxy service in retrieving resources, in accordance with a preferred embodiment of the invention;

FIG. 4 is a schematic diagram of how a local proxy service combines global and local resource sets in accordance with a preferred embodiment of the invention; and

FIG. 5 is a schematic diagram indicating how the proxy service is assisted by providing maps as resources in the resolution systems.

### DETAILED DESCRIPTION OF THE PREFERRED EMBODIMENTS OF THE INVENTION

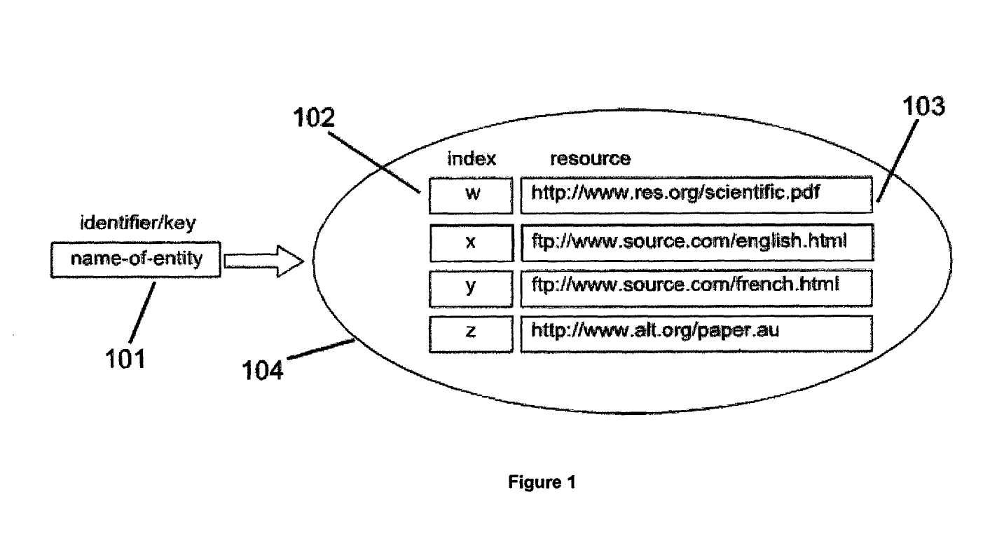

A conventional information handling system is illustrated schematically in FIG. 1. An example is the Handle System referred to above. An identifier or key 101 contains the name of an entity, the entity having an associated resource set 104. The resource set 104 includes one or more resources 103, examples of which are shown. Each resource has a corresponding index 102. Although not shown in the Figure, each resource also has a “type”, which indicates the type of information in the resource. The type is, for example, a url or a public key or some other form of location for information. In this example, the entity is, for example, a specific volcano, and each resource provides information relating to that volcano. Typically, the information is in different formats and in different languages.

Such resource sets 104 are registered with a solution administration system, which has a registration management function. This ensures that the data structures retain the correct format, by parsing data with each change of information to the system.

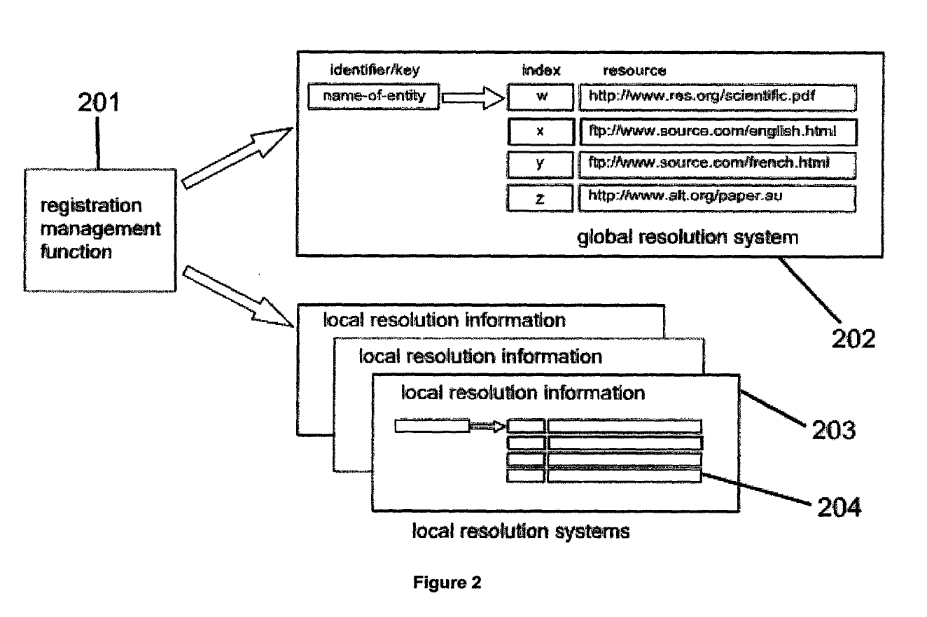

FIG. 2 is an illustration of one preferred embodiment of the invention. Within the entire network, a registration management function 201 manages a global resolution system 202 which contains all the available resources, duly indexed and typed. The global resolution system typically contains a multitude of sets of resources, each set having its own unique identifier. In addition, the registration management function supports one or a plurality of local resolution systems 203, each of which contains one or more sets 204 of resources, labelled with corresponding identifiers which are unique to the local resolution system.

The information stored in each local resolution system 203 is relevant to the local context, and is, for example, in just one language, or be at one level of difficulty appropriate for adults or children. ???????

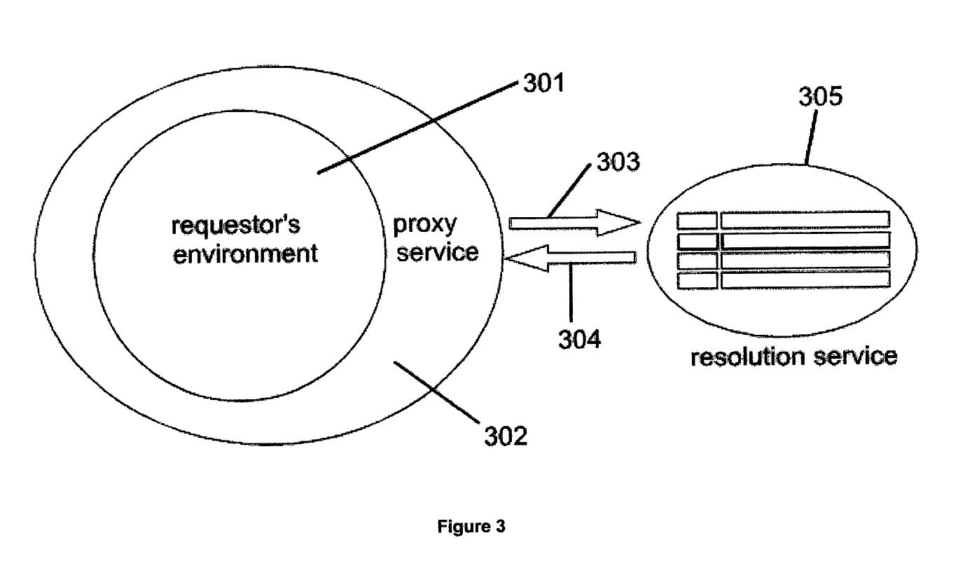

As illustrated in FIG. 3, a proxy service 302 takes the place of a requester or user, when issuing a request for the resolution of information from the network. This is required because, for the information to be more relevant to the local requester, information from the corresponding local resolution system has to be merged using the index values with the information from the global resolution system, and presented in a context-specific manner to the requester. Thus the requester, in the requester's environment 301, issues a resolution request through a proxy service 302 which communicates, as indicated by arrows 303 and 304, with the corresponding local and global resolution systems, referred to as the resolution services 305. The service that combines the resources uses the concept of proxy to manage requests for the resolution of an identifier into a resource collection, and to merge the returned resources with information stored in a local data storage that replicates the global format. Thus the data structure of each local resolution system 204 mirrors the structure of the global resolution system 202. They have the same format. The computer system uses a local proxy service 302 to retrieve a globally identified resource set and its local equivalent. These two equivalent data structures are then combined or merged to supply a contextual version of the resource to the requester in the requester's environment 301.

This system is particularly useful for large scale information systems where a computer resource, such as a location of some data, has associated resources that help with the interpretation of that resource. The system allows different data to be associated with the main resource set, dependent on the requirements of the requester.

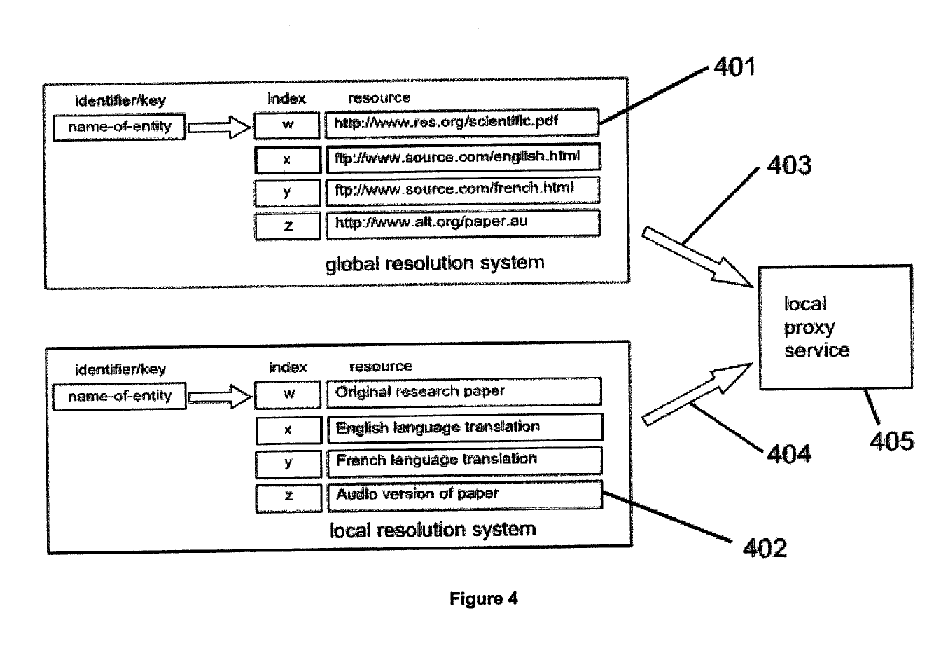

As illustrated in FIG. 4, equivalent data sets 401 and 402 from the global and local resolution systems respectively are retrieved and fed, along data paths 403 and 404, to the local proxy service 405 for the merger process and the presentation of the merged information to the requester. The proxy service resolves the resource and queries the local data store for matching data that are maintained in the same sequence as the data in the resolution system. The resolved data and the localisation information are combined and forwarded to the requester as a set of qualified resources.

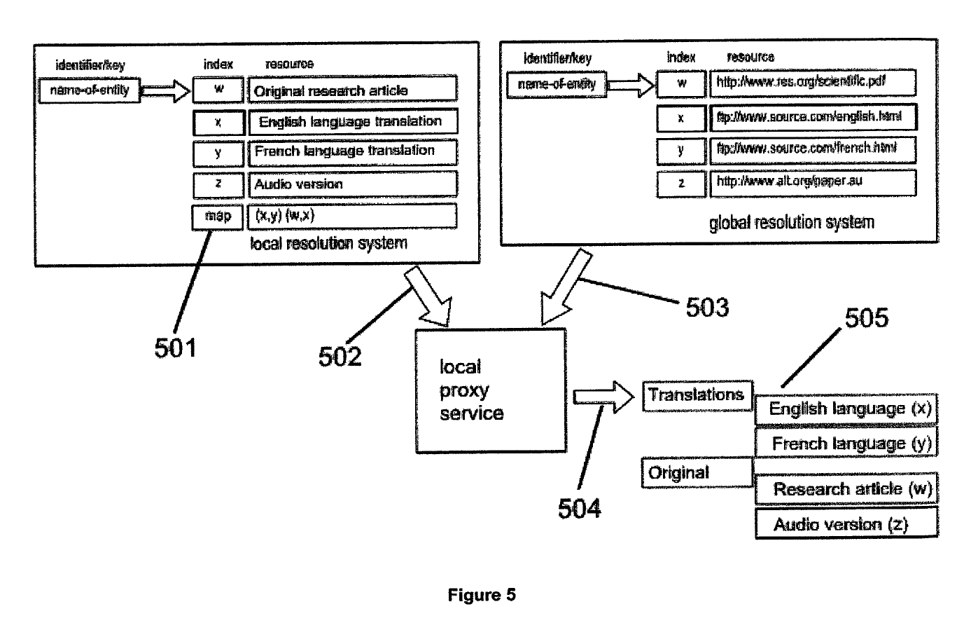

As shown in FIG. 5, the proxy service is assisted significantly by the provision of a map 501 in at least the local resolution system. The map 501 is a type of resource which indicates a sequence of presentation of the other resources in the same set, using their indexes. In the example of FIG. 5, the map 501 is provided along with the other resource information 502, 503 to the local proxy service which then merges the local and global resource information to output, in the process 504, a presentation 505 which is specific to the local context.

This therefore is a preferred capability of the local structure, by extending it to provide a context-specific presentation of resources by coordinating the sequence in which the resources are made available to the requester.

The implementation of this system requires that data be parsed into separate resources upon registration with the system. By synchronising any administrative updates, consistent responses can be provided using the proxy service which combines data from the two records and reorganises the data according to the local map.

In the example of FIG. 5, which repeats the examples of resources shown in FIG. 4, but adds a local map 501, the entity, for example a volcano, has related to it an original research article, an English language translation and a French language translation of that article, an audio clip of that article, and a map indicating the order X Y W Z, i.e. an instruction to present the information in the order shown: first the translations, English followed by French, and then the original material, the research article followed by the audio version.

Although specific examples have been given as embodiments of the invention, it will be appreciated that the invention may be implemented in other ways. Provided the local format of the set of resources is the same as the global format for the resources, the structure may take on any form to suit the intended purpose. The data set in the example given, has specific locations for the indexes and for the type, but this information may be provided in alternative ways.

1. An information handling system for use on a network storing information in the form of multiple resources, comprising:
a global resolution system, which is programmed to return, in response to a lookup request specifying a unique identifier selected from a multitude of unique identifiers, a set of indexed resources corresponding to that one identifier specified in the lookup request;
at least one local resolution system, which is programmed to return, in response to a lookup request specifying a unique identifier selected from a multitude of unique identifiers, a set of indexed resources corresponding to that one identifier specified in the lookup request;
and a registration management system for organising the content of the global and local resolution systems;
wherein each local resolution system is arranged to use a local data structure for its resources which mirrors the global data structure for its resources, and wherein each local data structure stores, as its resources, indexed, locally-contextual descriptions of the corresponding resources of the global resolution system.

2. An information handling system according to claim 1, comprising a local proxy service system operable, in response to local resolution requests specifying a unique identifier, to merge the indexed global resources corresponding to that identifier with their corresponding locally-contextual descriptions, using the global and local resolution systems, and to provide a local context-specific presentation of the merged resources and descriptions.

3. An information handling system according to claim 1, in which each said set of indexed resources and each set of indexed descriptions includes a map for the data structure of that identifier, indicative of a sequence in which the resources or descriptions are to be made available to a requester using the corresponding resolution system.

4. A system according to claim 1, in which the global and local resolution systems use identifiers such as those defined in the Handle System.

5. An information handling system according to claim 1 in a networked computer environment.

6. A process of forming a relationship between global resources and local descriptions of those resources by storing them in global and local data structures with mirrored formats, such that a global resolution system is capable of returning, in response to a lookup request specifying a unique identifier selected from a multitude of unique identifiers, a set of indexed resources corresponding to that one identifier specified in the lookup request, and at least one local resolution system is capable of returning, in response to a lookup request specifying a unique identifier selected from a multitude of unique identifiers, a set of indexed resources corresponding to that one identifier specified in the lookup request; in which the resources of the local resolution system comprise the corresponding local descriptions of the global resources.

7. A process according to claim 6, comprising responding to a local resolution request specifying a unique identifier to merge the indexed global resources corresponding to that identifier with their corresponding local descriptions, and providing a local context-specific presentation of the merged resources and descriptions.

8. A process according to claim 6, comprising storing, in each set of indexed resources and each set of indexed local descriptions, a map for the data structure of that set, indicative of a sequence in which the resources or descriptions are to be made available to a requester using the corresponding resolution system.

9. A process according to claim 6, in which the global and local resolution systems use digital object identifiers for identifying each set of resources.

10. A process according to claim 9 wherein the digital object identifiers are defined in the Handle System.

11. A computer network programmed with an information handling system according to claim 1.

12. A storage medium comprising a computer program for forming a relationship between global resources and local descriptions of those resources, the program storing the global resources and local descriptions in global and local data structures with mirrored formats, such that a global resolution system is capable of returning, in response to a lookup request specifying a unique identifier selected from a multitude of unique identifiers, a set of indexed resources corresponding to that one identifier specified in the lookup request, and at least one local resolution system is capable of returning, in response to a lookup request specifying a unique identifier selected from a multitude of unique identifiers, a set of indexed resources corresponding to that one identifier specified in the lookup request; in which the resources of the local resolution system comprise the corresponding local descriptions of the global resources.

13. A method of forming a relationship between global resources and local descriptions of the global resources in response to stored global and local data structures of the global resources, comprising
causing a global resolution system to return a set of indexed resources corresponding to that one identifier specified in the lookup request, causing at least one local resolution system to return a set of indexed resources corresponding to that one identifier specified in the lookup request; in which the resources of the local resolution system comprise the corresponding local descriptions of the global resources.

14. The method of claim 13 wherein the global resolution system is returned in response to a lookup request specifying a unique identifier selected from many unique identifiers, and the local resolution system is returned in response to a lookup request specifying a unique identifier selected from many unique identifiers.

15. The method of claim 13 further including storing the resources in the global and local data structures so they have mirrored formats.
